(19) United States
(12) Patent Application Publication
(10) Pub. No.: US 2003/0030652 A1
(43) Pub. Date: Feb. 13, 2003

(54) Apparatus and methods for advertising in a transparent section in an interactive content page

(75) Inventors: James A. Billmaier, Woodinville, WA (US); Anthony F. Istvan, Snoqualmie, WA (US); Robert E. Novak, Santa Clara, CA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: digeo, inc., Kirkland, WA

(21) Appl. No.: 10/124,806

(22) Filed: Apr. 16, 2002

Related U.S. Application Data
(60) Provisional application No. 60/284,329, filed on Apr. 17, 2001.

(51) Int. Cl. H04N 7/16; H04N 9/74; G09G 5/00

(52) U.S. Cl. 345/629; 725/135; 348/586; 348/584

(57) ABSTRACT

A method of providing a video enhancement to an interactive television content page, includes providing a graphical overlay with a transparent section; providing a graphical underlay capable to show an underlay content; and displaying the underlay content through the transparent section. An apparatus for providing a video enhancement to an interactive television content page, includes a display engine capable to display a graphical overlay having an associated transparent section and to display an underlay content on a graphical underlay and through the associated transparent section; and a processor communicatively coupled to the display engine and capable to execute the display engine.

### CROSS-REFERENCE TO RELATED APPLICATION

This application claims priority to U.S. Provisional Application No. 60/284,329, by common inventors James A. Billmaier, Anthony F. Istvan, and Robert E. Novak, filed Apr. 17, 2001, entitled “HOLE IN WINDOW,” and assigned to the same assignee as the present application. Application No. 60/284,329 is fully incorporated herein by reference.

### BACKGROUND OF THE INVENTION

1. Field of the Invention

This disclosure relates generally to electronics and communications, and more particularly to interactive television (iTV) systems.

2. Description of the Related Art

An interactive television system typically includes a customer premise equipment such as a set top box (STB). Low-power or limited-capability STBs can display graphics pages that are static or that change little over time.

However, these types of STBs have so far been limited in their capability to display multi-media content or high quality video.

The restricted types of multimedia and video so far available in graphics pages displayed by low-power interactive television systems limit the visual interest and advertising value of those graphics pages. For example, motion video advertisements (such as television commercials) are more visually interesting and are thought to be substantially more effective at getting a viewer's attention than static advertisements (such as banner ads), but are not typically available given the restrictions of low-power or limited-capability interactive television systems.

### BRIEF DESCRIPTION OF THE SEVERAL VIEWS OF THE DRAWINGS

Non-limiting and non-exhaustive embodiments of the present invention are described with reference to the following figures, wherein like reference numerals refer to like parts throughout the various views unless otherwise specified.

FIG. 1 is a schematic block diagram of a video casting network according to an embodiment of the invention.

FIG. 2 is a block diagram of an interactive television client system according to an embodiment of the invention.

FIG. 3 is a block diagram of a set top box (or other customer premise equipment) according to an embodiment of the invention.

FIG. 4 is a block diagram of a memory device that is capable to store various codes (or modules) or data according to an embodiment of the invention.

FIG. 5A is a block diagram illustrating underlay content displayed in an area of a graphical underlay (video backplane).

FIG. 5B is a block diagram illustrating an interactive content page with a transparent section showing the underlay content of FIG. 5A.

FIG. 6 is a flowchart illustrating an advertising method according to an embodiment of the invention.

FIG. 7A is a block diagram illustrating underlay contents composited as a single video and displayed in various areas of a graphical underlay (video backplane).

FIG. 7B is a block diagram illustrating an interactive content page (A) with a transparent section showing an underlay content.

FIG. 7C is a block diagram illustrating another interactive content page (B) with a transparent section showing an underlay content.

FIG. 7D is a block diagram illustrating another interactive content page (C) with a transparent section showing an underlay content.

FIG. 7E is a block diagram illustrating another interactive content page (D) with a transparent section showing an underlay content.

FIG. 7F is a block diagram illustrating another interactive content page (E) with multiple transparent sections, where each transparent section shows a different underlay content.

FIG. 8 is a flowchart illustrating an advertising method according to another embodiment of the invention.

### DETAILED DESCRIPTION

Embodiments of an apparatus and/or method for providing high quality video advertisements in an interactive television system are disclosed herein. As an overview, an embodiment of the invention provides an apparatus and method that permit video enhancements to otherwise static interactive television (iTV) content pages for systems with limited resources. A graphical overlay (on a graphical foreplane) that shows an interactive content page may include a transparent section that can display content being broadcast in a graphical underlay (e.g., video backplane). The transparent section may be, for example, a transparent hole or window that permits the viewing of at least a portion of the graphical underlay. The transparent section permits the display of underlay content (e.g., a video advertisement) being shown on the graphical underlay. The underlay content can be scaled and/or formatted (and/or zoomed, cropped, and/or repositioned) to fit within the dimensions of the transparent section of the interactive content page. The interactive content page is typically shown via a first channel, while the underlay content can be shown via a second channel that may be, for example, a video channel dedicated for broadcasting advertisement content.

In one embodiment, a set top box (or other customer premise equipment) can silently tune to the channel that is broadcasting the underlay content.

In another embodiment, at least one interactive content page can be selected (viewed) from a selection of multiple interactive content pages can be selected, where each interactive content page has an associated transparent section for displaying underlay content. The displayed underlay content may, for example, typically relate to the selected (viewed) interactive content page.

In another embodiment, an interactive content page may include multiple transparent sections, where each transparent section shows a different underlay content.

Embodiments of the invention may be particularly useful for thin client solutions (or limited-capability STBs or other customer premise equipment) where, for example, the central processing unit capacity for handling streaming video or Flash-based commercials is not available. Thus, an embodiment of the invention permits the showing of compelling visuals even on “thin” client set top boxes. As an example, high quality advertisements may be shown through a transparent section in a graphics menu page or other interactive content pages.

In the description herein, numerous specific details are provided, such as examples of components and/or methods, to provide a thorough understanding of embodiments of the invention. One skilled in the relevant art will recognize, however, that embodiments of the invention can be practiced without one or more of the specific details, or with other apparatus, systems, methods, components, materials, parts, and/or the like. In other instances, well-known structures, materials, or operations are not shown or described in detail to avoid obscuring aspects of the invention.

Reference throughout this specification to “one embodiment,” “an embodiment,” or “a specific embodiment” means that a particular feature, structure, or characteristic described in connection with the embodiment is included in at least one embodiment of the present invention. Thus, the appearances of the phrases “in one embodiment,” “in an embodiment,” or “in a specific embodiment” in various places throughout this specification are not necessarily all referring to the same embodiment. Furthermore, the particular features, structures, or characteristics may be combined in any suitable manner in one or more embodiments.

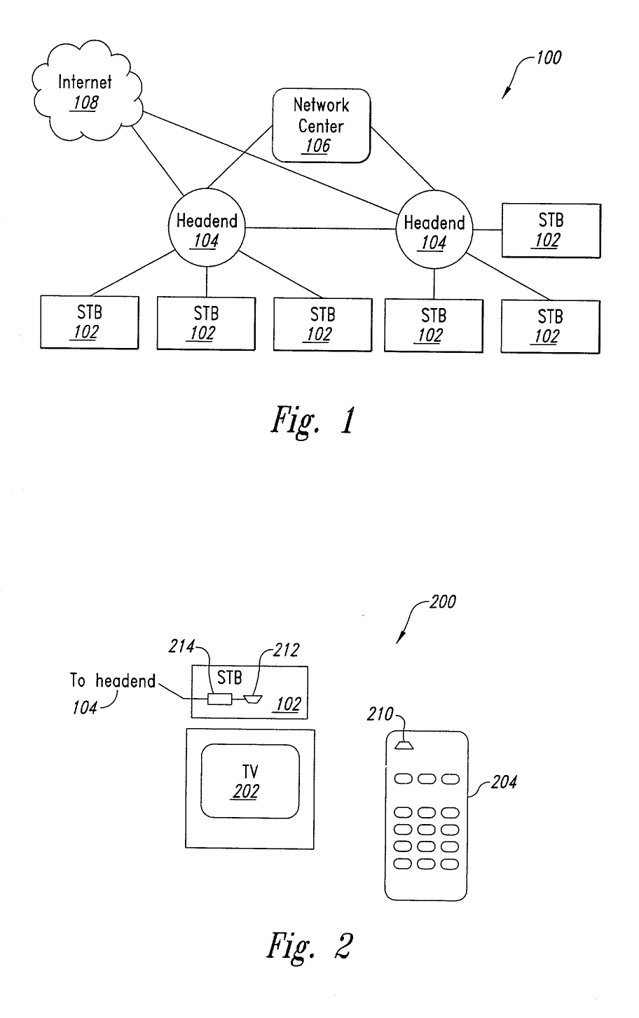

Referring now to FIG. 1, there is shown a block diagram of a video casting network 100, such as a cable network, that can implement a specific embodiment of the invention. Of course, the illustrated network topology is provided for example purposes only, and other network topologies may be used within the scope of the invention. In one implementation, the network 100 includes a plurality of set top boxes (STBs) 102 or other types of customer premises equipment (CPE) located, for instance, at customer homes. Generally, an STB 102 is a consumer electronics device that serves as a gateway between a customer's television and a broadband communication network, such as a cable network. As its name implies, an STB 102 is typically located on top of, or in close proximity to, a customer's television.

In one embodiment, an STB 102 receives encoded video/audio signals (including television signals) from the network 100 and decodes the signals for display on the television. Additionally, an STB 102 receives commands from a user (typically via a remote control device) and transmits such commands back to the network 100.

In various embodiments, each STB 102 is connected to a headend 104. In the context of a cable network, a headend 104 is a centrally-located facility where digital and analog cable TV (CATV) channels are received from a local CATV satellite downlink and packaged together for transmission to customer homes. In this case, a headend 104 functions as a local digital broadcast center.

The headends 104 may be coupled directly to one another or through a network center 106. In some cases, the headends 104 may be connected via a separate network, such as, for example, the Internet 108.

As described in detail hereafter, each STB 102 may be identified by a unique number, code, or address, such as an IP (Internet Protocol) address. Thus, a user of one STB 102 may indicate a particular STB 102 to receive an audio or video transmission by specifying the corresponding address. The network 100 then routes the transmission to its destination using conventional techniques.

As an alternative to the cable network, other video casting networks may be used in accordance with other embodiments of the invention. For example, satellite TV delivery systems may be used. A satellite TV delivery system may include a direct broadcast satellite (DBS) system. A DBS system may include, for example, a small 18-inch satellite dish (which is an antenna that can receive a satellite broadcast signal); a digital integrated receiver/decoder (IRD), which separates each channel, and decompresses and translates the digital signal so that a television can show the digital signal; and a remote control device that transmits command signals. Programming for a DBS system may be distributed by, for example, multiple high-powered satellites in geo-synchronous orbit, with each satellite having multiple transponders. Compression (e.g., Moving Pictures Experts Group (MPEG) based compression) may be used to increase the amount of programming content that can be transmitted in the available bandwidth.

A digital broadcast center may be used to gather programming content, ensure the digital quality of the programming content, and transmit the signal up to the satellites for delivery. Programming content may be provided to the broadcast center from content providers (e.g., ABC, CNN, ESPN, and so on) via satellite, fiber optic cable, and/or special digital tape. Satellite-delivered programming content are typically immediately digitized, encrypted, and up-linked to the orbiting satellites. The satellites re-transmit the signal back down to every earth-station (or, in other words, every compatible DBS system receiver dish at, for example, homes and businesses of customers).

Some programming content may be recorded on digital videotape in the broadcast center, and the programming content can be broadcast at a later time or day. Before any recorded programming content are viewed by customers, technicians may use post-production equipment to view and analyze each tape to, for example, ensure audio and video quality. Tapes may then be loaded into, for example, a robotic tape handling system, and playback may be triggered by a computerized signal sent from a broadcast automation system. Back-up videotape playback equipment may ensure uninterrupted transmission at all times.

Referring now to FIG. 2, there is shown a block diagram of various components of an interactive television client system 200 according to a specific embodiment of the invention. The client system 200 typically includes a television 202, which is configured to receive and display, for example, standard analog or digital television signals or high-definition television (HDTV) signals. In this embodiment, the client system 200 includes an STB 102 with a tuner system 214 for receiving and demodulating video, audio, and/or other data from the network 100. The tuner system 214 may include a digital tuner configured to tune to a digital channel of the video casting network 100. Such digital channels typically broadcast compressed digital video to set top boxes. The tuner system 214 may also include an analog tuner configured to tune to an analog TV channel of the video casting network and to extract an analog TV signal therefrom. Such an analog tuner makes the STB 102 “backward compatible” with analog TV broadcasts.

In one embodiment, a remote control device 204 is provided for convenient remote operation of the STB 102 and the television 202. The remote control device 204 may communicate with the STB 102 and television 202 by using conventional techniques to adjust, for example, the volume of the television, the displayed channel, and the like. Such communication may occur, for example, by way of control codes being transmitted from a command transmitter 210 on the remote control device 204 to a command receiver 212 in the STB 102. The transmitter 210 and receiver 212 may include, for example, infrared or radio frequency communication devices.

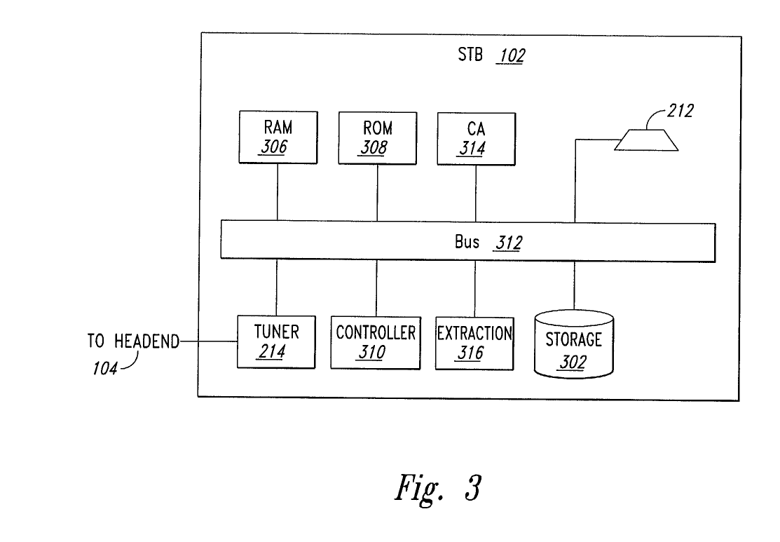

FIG. 3 illustrates an expanded diagram of a representative set top box (or other suitable customer premise equipment or processing device) 102 according to a specific embodiment of the invention. It is noted that the illustrated configuration of the set top box (STB) 102 in FIG. 3 is provided for example purposes only, and other types of configurations may be used within the scope of the invention. It is also noted that the components shown in FIG. 3 may be implemented in other types of customer premise equipment or other types of processing devices. The STB 102 includes a controller 310 that is in communication with the receiver 212, the tuner system 214, a storage system 302, a random access memory (RAM) 306, and a read only memory (ROM) 308. The controller 310 may be coupled to the other components of the STB 102, for example, via a bus 312.

In various embodiments, the controller 310 may be embodied as a microcontroller, a microprocessor, a digital signal processor (DSP) or other device known in the art. The controller 310 manages the operation of the STB 102, including, for example, the transmission and reception of video/audio/data information from the network 100, the storage of the video/audio/data information, and the like. As noted above, the controller 310 may perform these and other operations based on, for example, the control signals generated by the remote control device 204 (FIG. 2) and transmitted to the receiver 212.

The controller 310 can execute instructions stored in the storage system 302, ROM 308, and/or RAM 306 to achieve particular functions that will be discussed in further detail below. The controller 310 also typically performs other management functions of the STB 102. The controller 310 may also permit the tuner system 214 to tune to a channel transmitting content that is to be displayed on the television 202, or to switch from one channel to another channel transmitting content to be displayed on the television 202.

The RAM 306 may be configured to store data for temporary use. Similarly, the ROM 308 may be provided for storing more permanent data, such as fixed code and configuration information. In one embodiment, the ROM 308 may be used to store an operating system for the STB 102, such as Windows CEO or Linux®.

The storage system 302 may be, for example, a hard disk drive, a removable memory device, or any other suitable organization of volatile or nonvolatile memory. Such a storage system 302 may be used, for example, to store digital video for later viewing by a user. In another embodiment, the storage system 302 may be located externally from the STB 102.

In one embodiment, the STB 102 further includes a conditional access (CA) system 314 coupled to the tuner system 214. The CA system 314 restricts channels accessible by the STB 102 to authorized channels only. The CA system 314 may be implemented by using software and/or components available, for example, from MOTOROLA or SCIENTIFIC ATLANTA. A typical CA system 314 operates in cooperation with a corresponding CA server in a cable head-end 104.

In addition, the STB 102 may include a cable modem (not shown in the drawings) coupled to the video casting network 100 (FIG. 1), and typically coupled to the network 100 via the same RF cable as used to couple the tuner system 214 to the network 100. The cable modem is configured to receive digital data by demodulating an analog signal received from the network 100 and to transmit digital data by modulating the digital data to create an analog signal for transmission to the network 100. The cable modem may be implemented by using, for example, the DOCSIS or DAVIC standards. A typical cable modem operates in cooperation with a cable modem termination system at a cable headend 104.

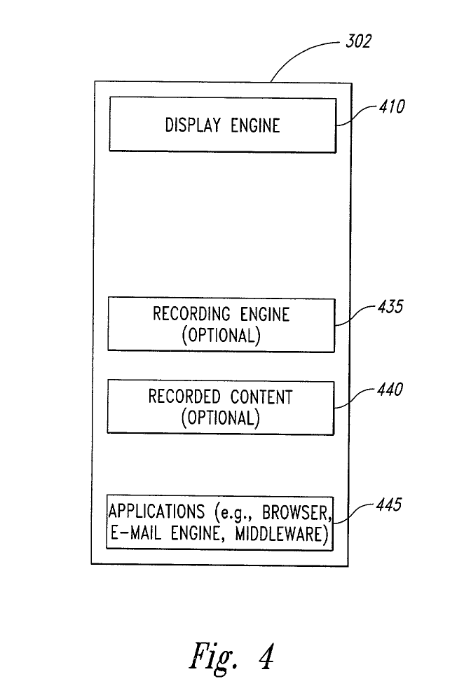

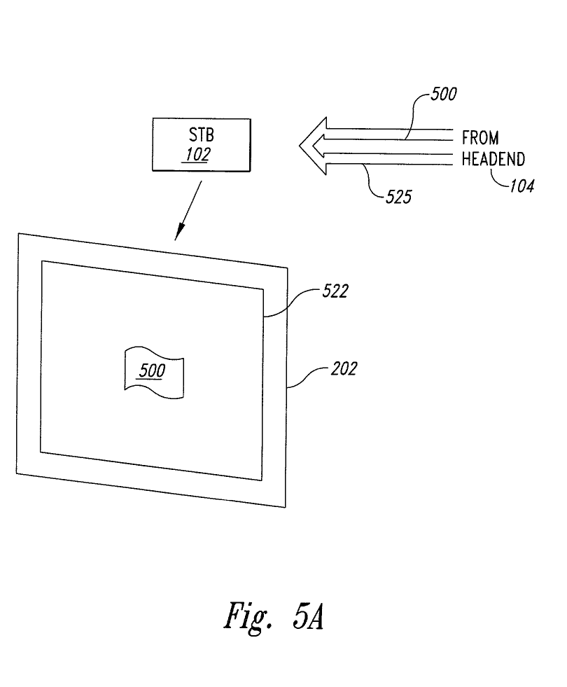

FIG. 4 is a block diagram of various applications that may be stored in a storage device (e.g., storage system 302 or RAM 306). For purposes of explaining the functionality of an embodiment of the invention, it is assumed that the various applications are stored in, for example, the storage system 302. A display engine 410 permits the controller 310 to perform at least one of the following functions: (1) to switch between or select channels that transmit content for display on a display device such as a television 202; (2) to display a graphical overlay (e.g., an interactive content page) from a first channel and/or underlay content from a second channel; (3) to format the graphical overlay so that a transparent section is included in the graphical overlay; and/or (4) to format and scale the underlay content displayed through the transparent section of the graphical overlay. As noted below, at least some of the functions described in (2) through (4) above may be performed by components and/or software at an upstream stage such as a broadcast center (e.g., a cable head end 104).

It is noted that the display engine 410 may instead be hardware and/or software that is implemented as part of the controller 310. Therefore, the display engine 410 is shown as a separate module in the example in FIG. 4 for purposes of describing the functionalities of an embodiment of the present invention and should not be construed as limiting the scope of the present invention. The display engine 410 may typically perform the functions of a graphics engine and/or a video engine. Other functions that may be performed by the display engine 410 are described below.

An optional recording engine 435 may perform functions such as recording commercial content or copying data files as recorded content 440.

Other applications 445 may represent one or more applications. The applications 445 may include, for example, a browser for accessing a Uniform Resource Locator (URL) address on the Internet and for permitting web pages in a URL address to be displayed on the screen of the television 202. The applications 445 may also include an e-mail engine that can detect when an electronic mail (email) message has been received by the set top box 102. The email engine can also permit the display of an e-mail message on the screen of the television 202, the creation and transmission of an e-mail message from the STB 202, and/or other e-mail processing functions. The applications 445 may also include middleware (sometimes called “plumbing”) for connecting two sides of an application and passing data between them. The applications 445 may also include other engines that are used in the typical operation of a customer premise equipment such as an STB, and/or other engines that permit other external components to function with the components of an STB.

The various engines discussed herein may be, for example, software, commands, data files, programs, code, modules, instructions, or the like, and may also include suitable mechanisms. It is noted that the modules shown in FIG. 4, such as the recording engine 435, may instead be hardware and/or software that is implemented as part of the controller 310 or as part of other suitable components that interact with the set top box 102. Additionally, the various functionalities of the separate modules in FIG. 4 may be combined in one or more modules. Therefore, the various modules in FIG. 4 are shown only as examples and as separate drawing blocks for purposes of describing the functionalities of an embodiment of the present invention and should not be construed as limiting the scope of the present invention

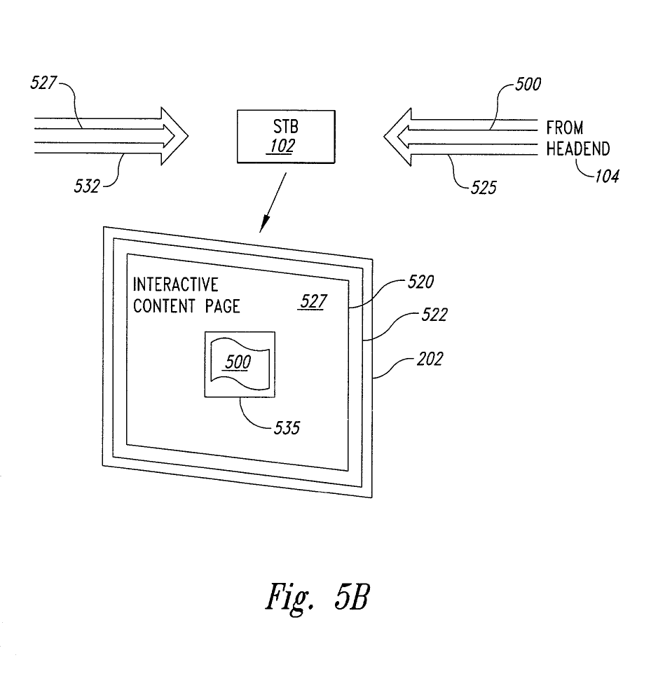

FIGS. 5A to 5B are block diagrams illustrating an operation of a specific embodiment of the invention. Various embodiments of the invention advantageously provide, for example, a method of delivering high quality video motion advertising as seen through a transparent section 535 (FIG. 5B) in an interactive content page 527 or other graphical overlay. The interactive content page 527 may be shown, for example, on the television 202 screen (FIG. 2).

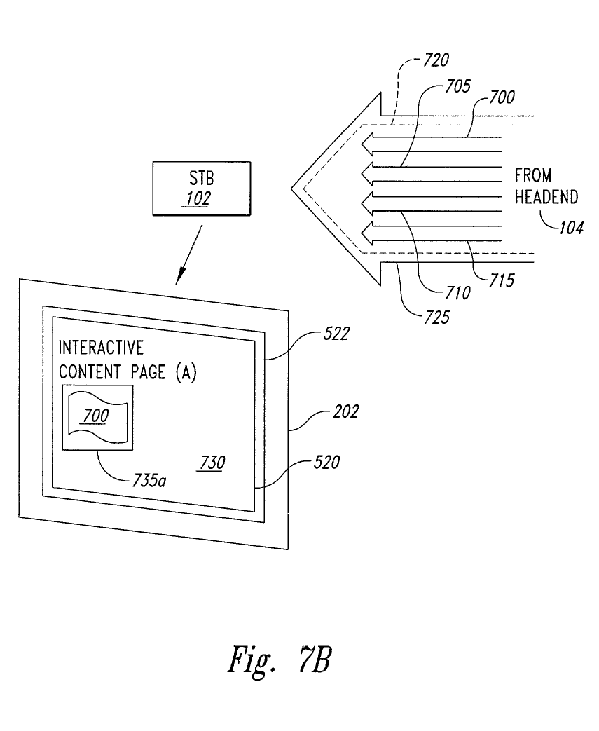

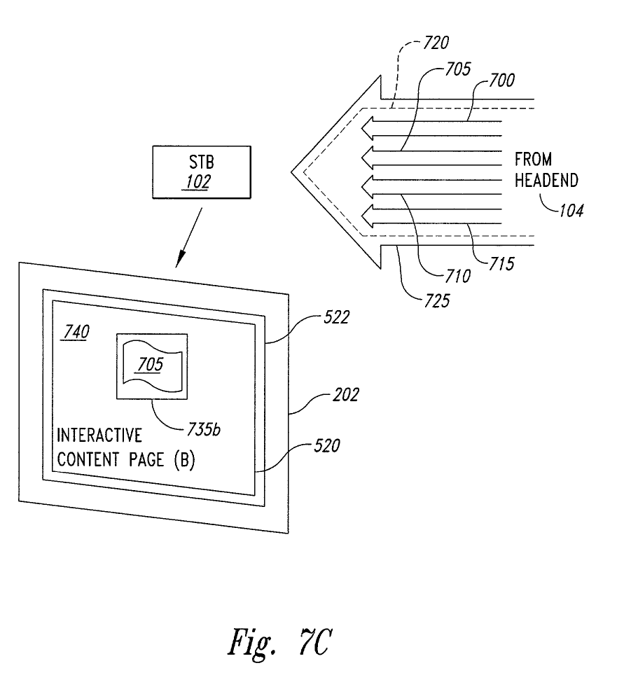

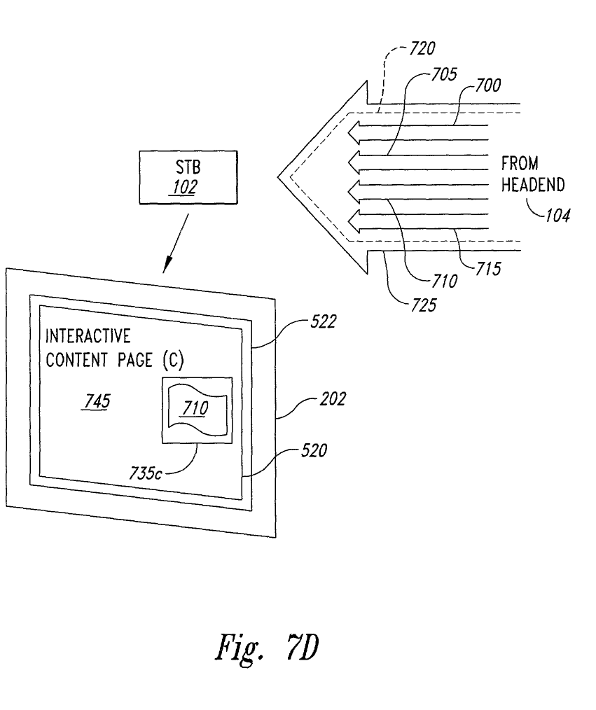

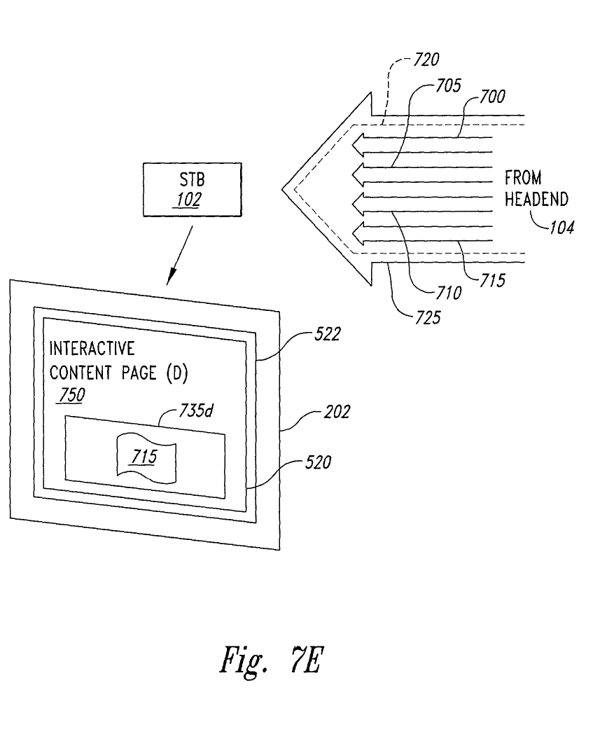

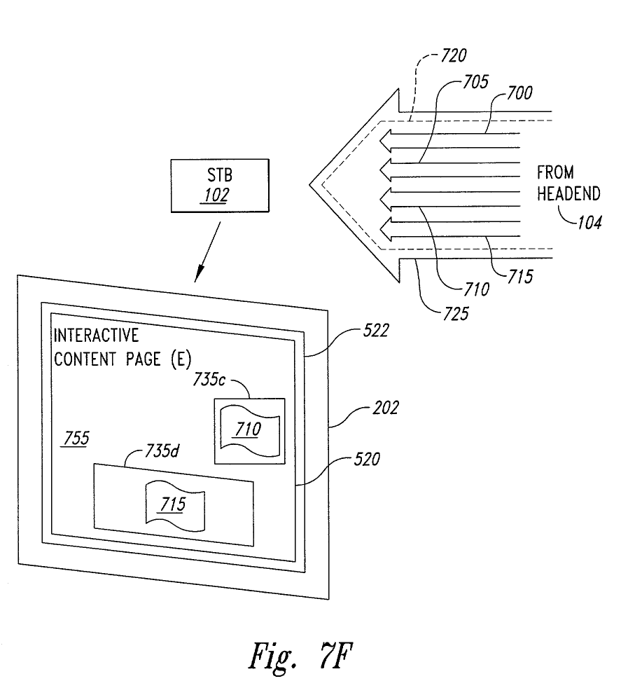

Referring first to FIG. 5A, an underlay content 500 is transmitted from the headend 104 to the STB 102 (or from a digital broadcast center in other implementations). The underlay content 500 is displayed an area of a graphical underlay (video backplane) 522. In one embodiment, the underlay content 500 is broadcast as a video signal along a channel 525. In one embodiment, the position and size of the underlay content 500 within a single video frame (e.g., a video image surrounded by “black” areas within a full video frame) is set (such as at the headend 104) prior to transmission, thus allowing the underlay content 500 to be placed in a fixed position on the graphical underlay 522. Performing scaling prior to transmission consumes less bandwidth, since the black areas (over which the interactive content page 527 is to be positioned) are easier to compress. As shown subsequently in FIG. 7A, in another embodiment, multiple underlay contents may also be transmitted from the headend 104 to the STB 102 and displayed on the graphical underlay 522.

In FIG. 5B, assume that an interactive content page 527 is loaded as graphical overlay 520 on the television 202 screen. The interactive content page 527 may be loaded based upon an action of a user (e.g., by selection of a button on a remote control device to load the content page 527) or by a user opting to allow automatic launching of the content page 527 by use of a triggering mechanism.

One implementation of the synthetic channels (interactive television pages) would be, for example, by way of the cable modem integrated into the STB 102. The cable modem receives the same RF signal as received by the tuner system 214 (FIG. 3). A splitter may be used to provide the RF signal to both tuner system 214 and modem. The cable modem provides a method for internet protocol (IP) packets to be transmitted between the STB 102 and the network 100. As an example, when a user hits a remote button to pull up a synthetic channel's “home page” such as the Shopping page, the STB 102 uses IP packets to send a request for the Shopping page upstream to the head-end 104. The request includes the URL of the Shopping page. A server at the headend 104 responds using IP packets to send the Shopping page downstream to the STB 102. The Shopping page is sent using hypertext markup language (HTML) or a protocol similar to HTML which is compatible with a display on televisions.

Other techniques can be used to obtain content for the interactive content page 527. The content can be obtained from a channel by tuning to that channel with an in-band tuner (such as the same tuner used to tune to a video channel). The content in that channel can be carousel broadcast, so as to allow the tuner to obtain the information when needed. The content for the interactive content page 527 may also be obtained from an out-of-band channel (such as that used for electronic program guide data), or from local storage like a PVR.

The interactive content page 527 has a transparent section 535 that shows a portion of the graphical underlay 522, and the underlay content 500 can be seen through the transparent section 535. It is noted that the transparent section 535 may vary in size and/or shape. For instance, the transparent section 535 does not have to visually appear as a rectangle. The transparent section 535 (and the video shown therein) can be L-shaped or made of portions that are not visually adjacent.

The interactive content page 527 is typically transmitted along a channel 532 from the headend 104 prior to being displayed on the television 202 screen. The underlay content 500 may be formatted/scaled to fit within the dimensions of the transparent section 535 and shown on its own channel 525. The display engine 410 may format/scale the underlay content 500 to fit within the transparent section 535 in one embodiment where the STB 102 has such processing capability, or the underlay content 500 may be formatted/scaled at the headend 104 to fit within the transparent section 535 prior to broadcast to STB 102 via channel 525 in other embodiments. The tuner system 214 tunes to the channel 532, and the interactive content page 527 is shown on the television 202 screen, and the tuner system 214 also tunes to the channel 525 so that the underlay content 500 is broadcast on the graphical underlay 522.

The underlay content 500 may be, for example, a broadcast video. Of course, the underlay content 500 may also be an image, picture, text, other information, or a combination of information. Other possible sources include a video-on-demand (VOD) server. In one embodiment, the video from a VOD can be synchronized with the user's actions. For instance, the video can be streamed from the VOD for presentation within the transparent section 535 in response to the user clicking a “See video” icon on the interactive content page 527 or in response to other user activity, thus allowing the video advertisement to start or stop as needed. As a variation to the VOD source, a PVR or other local storage can be the source of the video (which may have been previously downloaded into the PVR).

As an example in one implementation, the video signal of an underlay content 500 can be broadcast along a channel, such as a virtual channel, prior to displaying the underlay content 500 on the graphical underlay 522. Features and/or enhancements for implementing a virtual channel are of the type available from, for example, WINK COMMUNICATIONS, INC., 1001 Marina Village Parkway, Suite 100, Alameda, Calif., 94501.

In one embodiment, the display engine 410 (FIG. 4) permits the underlay content 500 to be shown after the interactive content page 527 is loaded on the television 202 screen. The display of the interactive content page 527 and the underlay content 500 are coordinated at, for example, the headend 104 so that when the user selects the interactive content page 527 to be displayed on the television 202 screen, then underlay content 500 is concurrently or subsequently shown through the transparent section 535.

For set top boxes with a single tuner (e.g., a DCT-2000 STB), the underlay content 500 is typically shown after the interactive content page 527 is downloaded to the set top box. The underlay content 500 may also be broadcast in a periodic or repeating manner, so that the viewer may see the underlay content 500 at least one time while viewing the interactive content page 527. Set top boxes with multiple tuners can be used in one embodiment to concurrently present multiple underlay content (from different video sources, including those recorded in a personal video recorder or PVR or other storage device) through one or more transparent sections.

Alternatively or in addition for STBs 102 having sufficient processing and storage capability, the display engine 410 may also display an underlay content 500 that is obtained from a suitable storage device such as storage system 302. For example, the underlay content 500 may be downloaded from the headend 104, stored in the storage system 302 by the recording engine 435 (FIG. 4), displayed at a portion of the graphical underlay (video backplane) 522 by the display engine 410, and shown through the transparent section 535 of the interactive content page 527.

In one embodiment, the recording engine 435 (FIG. 4) may record content that is stored as recorded content 440. The recorded content 440 may be, for example, pre-recorded advertisement that is useful for advertisers in cable systems that do not provided dedicated broadcast channels for broadcasting advertisements for display through the transparent section 535.

In another embodiment, when an ATVEF trigger (or other triggering mechanism) arrives at the STB 102 (or other customer premise equipment), an ATVEF notification graphic item is displayed on the television 202 screen. If the viewer decides to view the information associated with the ATVEF notification graphic item, then the viewer may, for example, press an acknowledgement button on the remote control device 204. An associated graphics page (e.g., an interactive content page 527) may then be displayed on the television 202 screen. An underlay content 500 that is related to the graphics page may then be displayed through a transparent section 535 of the graphics page. Other types of triggering methods are provided by, for example, WINK COMMUNICATIONS, INC. of Alameda, Calif. and WORLDGATE, INC. of Edmonton, Alberta, Canada.

As an example, the viewer may be watching the television 202 and tuned to a channel (e.g., Channel number “2”) and watching a program such as a Major League Baseball game. During the program, when a user makes a selection, a triggering mechanism (e.g., an ATVEF trigger) launches a graphics page that appears on the television screen. The tuner system 214 then tunes to a channel 525 (which may be, for example, channel “709”) that broadcasts a video related to graphics page. The video is displayed through the transparent section of the graphics page. When the user closes the graphics page, the tuner system 214 tunes back to channel number “2.” During this entire sequence, in one embodiment, the channel number displayed by the STB 102 (if STB 102 displays such channel numbers) is channel number “2.”

It is also noted that the use of triggers is not required in an embodiment of the invention. Typically, the user may select the interactive content and the underlay content will appear in the transparent section of the graphical overlay at the current position of the underlay content in the broadcast stream being transmitted from the headend 104 to the STB 102.

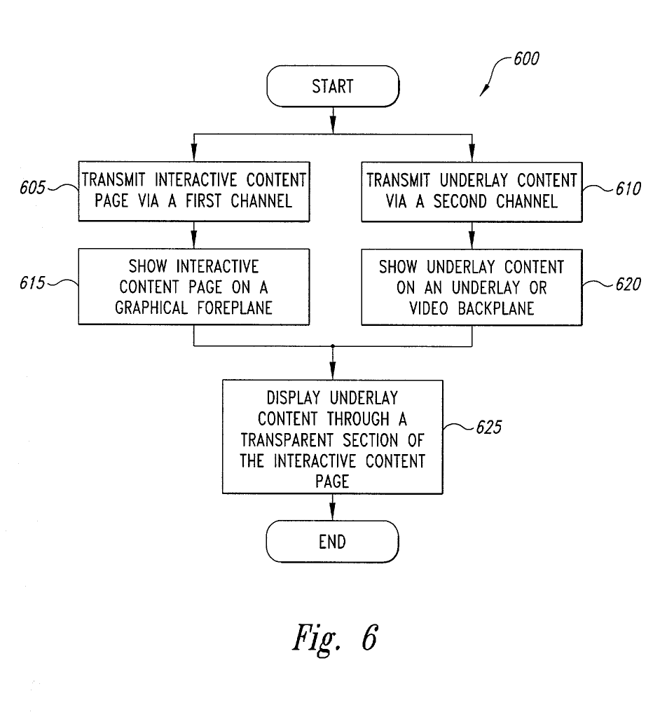

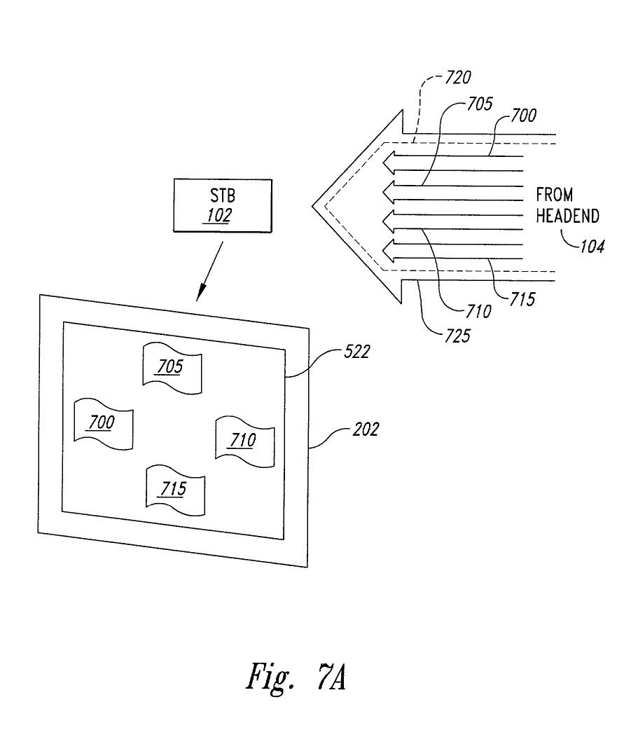

FIG. 6 is a flowchart showing a method 600 of advertising according to a specific embodiment of the invention. The method 600 may run continuously or at representative intervals. An interactive content page is transmitted (605) via a first channel, and underlay content is transmitted (610) via a second channel. The interactive content page is shown or loaded (615) on a graphical foreplane, and the underlay content is shown or loaded (620) on a graphical underlay (or video backplane). It is to be appreciated that the method 600 is not intended to necessarily and strictly represent the timing of the sequence of events. For instance, in one embodiment, the interactive content page 527 is transmitted and shown at 605 and 615, prior to transmission and presentation of the underlay content 500 at 610 and 620. This may occur, for instance, in implementations where a single tuner is being shared for both underlay and overlay content.

In another embodiment, the underlay content is stored in memory after being transmitted via the second channel and prior to being shown on the graphical underlay. As an example, the interactive content page may be shown on a screen of a display device such as the television 202. The underlay content may be, for example, a video (or another type of video enhancement) showing a commercial related to the interactive content page. The user/viewer may, for example, issue commands, via remote control device 204 (FIG. 2) to show the interactive content page, or the user can have the option of automatically launching the interactive content page based upon a triggering mechanism. The underlay content can then be displayed or viewed (625) through a transparent section of the interactive content page.

FIGS. 7A to 7F are block diagrams illustrating another operation of an embodiment of the invention. Referring first to FIG. 7A, multiple underlay contents 700, 705, 710, and 715 are transmitted from the headend 104 to the STB 102. The underlay contents 700 through 715 are displayed in separate areas of the graphical underlay 522. In one embodiment, the underlay contents 700 through 715 are broadcast in separate channels or in a single composite video 720 along a channel 725. The display engine 410 (FIG. 4), which may have graphics processing capability, processes the single composite video 720. In one embodiment, the single composite video 720 is a broadcast television signal that is capable of handling multiple video images that are composited into a single graphical underlay 522 that can be used by multiple different overlays to provide excellent video in limited bandwidth/capability STBs. The display engine 410 (FIG. 4) can translate the position of each underlay content or the position can be fixed at a headend prior to transmission, thus allowing the multiple underlay contents 700 through 715 to be broadcast along the single broadcast channel 725 and placed in a fixed position on the graphical underlay 522. It is noted that the number of underlay contents shown in FIG. 7A may vary in number and size, and the position of the underlay contents on the graphical underlay 522 may also vary.

By broadcasting multiple underlay contents along the single channel 725, the multiple underlay contents may be prevented from having multiple audio streams. However, in another embodiment, the multiple underlay contents 700 through 715 are broadcast along separate channels or from a local storage device. This method allows each of the underlay contents to have an associated unique audio signal that can be heard by the user. This method also typically does not require any more bandwidth except for the small additional bandwidth requirement for the audio signal. The various channels or sources can be sequentially tuned to one after another by a single tuner, or concurrently tuned to by multiple tuners.

In FIG. 7B, assume that an interactive content page (A) 730 is loaded as a graphical overlay 520 on the television 202 screen. The interactive content page (A) 730 has a transparent section 735a that shows a portion of the graphical underlay 522. The underlay content 700 can be seen through the transparent section 735a. As similarly described above, in one embodiment, the underlay content 700 may be shown after the interactive content page (A) 730 is loaded on the television 202 screen. The underlay content 700 may be broadcast in a periodic or repeating manner to permit the user/viewer to see the entire underlay content 700 at least once.

Similarly, FIG. 7C shows the interactive page (B) 740 as being loaded as an overlay 520. The underlay content 705 can be seen through the transparent section 735b of interactive content page (B) 740.

Similarly, FIG. 7D shows the interactive page (C) 745 as being loaded as an overlay 520. The underlay content 710 can be seen through the transparent section 735c of interactive content page (C) 745.

Similarly, FIG. 7E shows the interactive page (D) 750 as being loaded as an overlay 520. The underlay content 715 can be seen through the transparent section 735d of interactive content page (D) 750.

In another embodiment, an interactive content page may have more than one transparent section. For example, as shown in FIG. 7F, an interactive content page (E) 755 has the transparent sections 735c and 735d for showing the underlay content 710 and underlay content 715, respectively. The number and sizes of the transparent sections in the interactive content page (E) 755 may vary.

As an example, interactive content page (A) 730 may be a graphics page for sports. Therefore, the underlay content 700 may be a sports advertisement. As another example, the interactive content page (B) 740 may be a graphics page related to finance. Therefore, the underlay content 705 may be an advertisement on finance or money matters. Similarly, the interactive content pages 745, 750, and 755 may relate to similar or other topics.

The various transparent sections in the interactive content pages may also be useful for giving the user/viewer/consumer a choice to view different commercials in the underlay contents. For example, assume that the multiple interactive content pages 730 through 755 relate to a particular car manufacturer (e.g., GENERAL MOTORS) and that each interactive content page relates to a different GM vehicle. For example, interactive content pages 730, 740, 745, and 750 may be related to SUVs, trucks, sedans, and sport coupes, respectively. If the viewer prefers SUVs, then he/she can select the interactive content page 730 and view the underlay content 700 which may be, for example, a video commercial on a particular SUV. Thus, in this specific example, there may be four different versions of the interactive content pages, and each interactive content page will show a particular underlay content that is, for example, a video commercial for a particular type of vehicle.

In another embodiment, the display engine 410 can determine the particular channel(s) to tune based upon the particular type of graphical overlay. For example, if the interactive television content page on the graphical overlay is designed by digeo, inc. of Kirkland, Wash., then the display engine 410 (along with tuner system 214) may select one or more hidden channels (assigned to digeo, inc.) to show in the transparent section the underlay contents that are broadcast from those hidden channels.

In an embodiment, each piece of video content can be described by a shape, a position, a size, and some unique identifier. The unique identifier can map to a channel and a time (or multiple times). Alternatively or in addition, the time component can be removed by assuming that a single video appears constantly on a single channel.

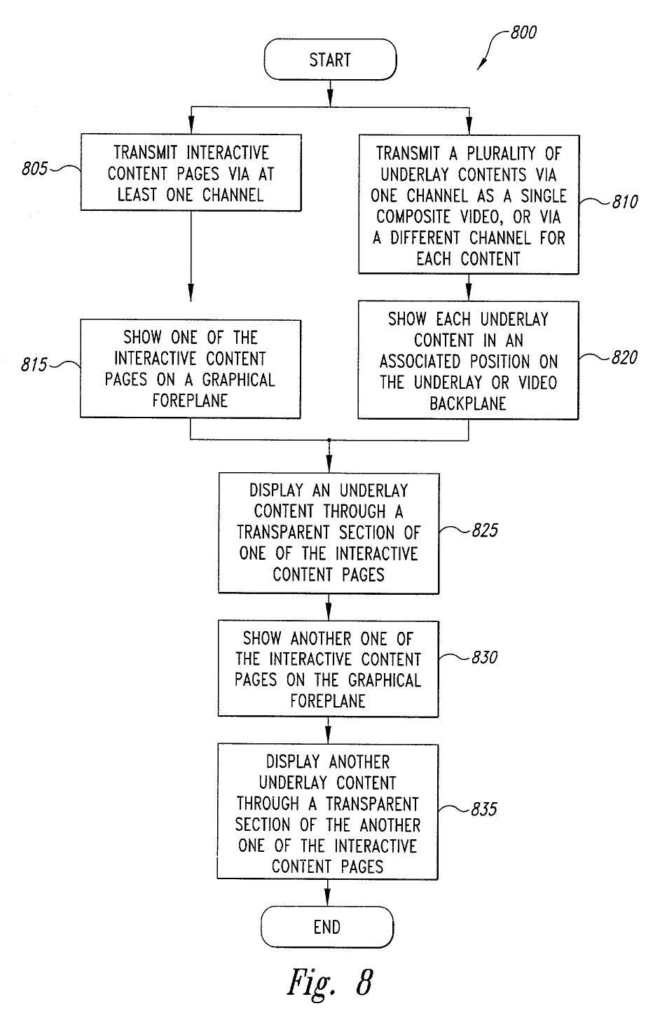

FIG. 8 is a flowchart illustrating an advertising method 800 according to another embodiment of the invention. The method 800 may run continuously or at representative intervals. A plurality of interactive content pages are transmitted (805) via at least one channel, and a plurality of underlay contents are transmitted (810) as a single composite video via another channel. In another embodiment, the underlay contents are each transmitted (810) via different channels. It is to be appreciated that the method 800 is not intended to necessarily and strictly represent the timing of the sequence of events. For instance, in one embodiment, the interactive content page 527 is transmitted and shown at 805 and 815, prior to transmission and presentation of the underlay content 500 at 810 and 820. This may occur, for instance, in implementations where a single tuner is being shared for both underlay and overlay content.

One of the interactive content pages is shown or loaded (815) on a graphical foreplane, and each of the underlay contents is shown or loaded (820) in an associated position on a graphical underlay (or video backplane). An underlay content can then be displayed or viewed (825) through a transparent section of the interactive content page. Another one of the interactive content pages may then be shown (830) on the graphical foreplane. Another one of the underlay contents can then be displayed or viewed (835) through a transparent section of the another one of the interactive content pages.

Other variations and modifications of the above-described embodiments and methods are possible in light of the foregoing teaching.

Further, at least some of the components of this invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in an machine-readable medium to permit a computer to perform any of the methods described above.

Additionally, the signal arrows in the drawings/figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

For example, underlying video content can be shown through a translucent overlay in one embodiment, instead of or in addition to being shown through transparent sections 535 of the interactive content page 527. In such an embodiment, portions of the interactive content page 527 can be a translucent overlay over the video (which may be in full screen). Portions of the underlying video frame may be “blacked out” or otherwise formatted to allow overlay content to be superimposed over non-video areas. Meanwhile, the relevant video content is shown through translucent regions of the interactive content page 527. In FIG. 5B, for example, the underlay content 500 can be presented through a translucent section 535.

Different shapes, sizes, and locations of the translucent sections of the interactive content page 527 can be provided. In one embodiment, different degrees of translucency can be provided for regions within a single page, such as via pixel alpha blending techniques.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

What is claimed is:

1. A method of providing a video enhancement to an interactive television content page, the method comprising:
providing a graphical overlay with a transparent section;
providing a graphical underlay capable to show an underlay content; and
displaying the underlay content through the transparent section.

2. The method of claim 1 wherein providing the graphical overlay comprises providing the graphical overlay based upon an action of the user.

3. The method of claim 1 wherein providing the graphical overlay comprises automatically providing the graphical overlay based upon a triggering mechanism.

4. The method of claim 1 wherein the graphical overlay is disposed along a graphical foreplane.

5. The method of claim 1 wherein the graphical underlay is disposed along a graphical backplane.

6. The method of claim 1 wherein the graphical overlay is transmitted over a first channel.

7. The method of claim 1 wherein the graphical overlay includes an interactive content page.

8. The method of claim 1 wherein the underlay content is transmitted over a second channel.

9. The method of claim 8 wherein the underlay content is stored in memory after being transmitted over the second channel and prior to being shown on the graphical underlay.

10. The method of claim 9 wherein the graphical overlay is associated with an interactive service provider and the second channel is assigned to the interactive service provider.

11. The method of claim 10, further comprising assembling, by the interactive service provider, a plurality of underlay contents from at least one advertiser.

12. The method of claim 11, further comprising assembling, by the interactive service provider, a plurality of underlay contents from at least one merchant.

13. The method of claim 1 wherein the underlay content includes video.

14. The method of claim 1 wherein the underlay content includes video advertisement.

15. The method of claim 14 wherein the video advertisement is associated with the graphical overlay.

16. The method of claim 1 wherein the underlay content is scaled and formatted to fit within a dimension of the transparent section.

17. An article of manufacture, comprising:
a machine-readable medium having stored thereon instructions to:
provide a graphical overlay with a transparent section;
provide a graphical underlay capable to show an underlay content; and
display the underlay content through the transparent section.

18. The article of manufacture of claim 17 wherein the machine-readable medium further includes instructions stored thereon to locally scale and format the underlay content to fit within a dimension of the transparent section.

19. A method of providing a video enhancement to an interactive television content page, the method comprising:
selecting a first graphical overlay having an associated transparent section;
providing a graphical underlay capable to show at least one underlay content;
displaying a first underlay content through the associated transparent section of the selected first graphical overlay;
selecting a second graphical overlay having an associated transparent section; and
displaying a second underlay content through the associated transparent section of the selected second graphical overlay.

20. The method of claim 19 wherein selecting the first graphical overlay comprises providing the first graphical overlay based upon an action of the user.

21. The method of claim 19 wherein selecting the first graphical overlay comprises automatically providing the first graphical overlay based upon a triggering mechanism.

22. The method of claim 19 wherein the first graphical overlay is disposed along a graphical foreplane.

23. The method of claim 19 wherein the second graphical overlay is disposed along a graphical foreplane.

24. The method of claim 19 wherein the graphical underlay is disposed along a graphical backplane.

25. The method of claim 19 wherein the first graphical overlay and second graphical overlay are transmitted over a first channel.

26. The method of claim 19 wherein the first graphical overlay includes an interactive content page.

27. The method of claim 19 wherein the first underlay content and second underlay content are transmitted over a second channel.

28. The method of claim 27 wherein the first graphical overlay is associated with an interactive service provider and the second channel is assigned to the interactive service provider.

29. The method of claim 28, further comprising assembling, by the interactive service provider, a plurality of underlay contents from at least one advertiser.

30. The method of claim 28, further comprising assembling, by the interactive service provider, a plurality of underlay contents from at least one merchant.

31. The method of claim 19 wherein the first underlay content and second underlay content are transmitted as a single composite video prior to being shown on the graphical underlay.

32. The method of claim 19 wherein the first underlay content and the second underlay content are transmitted along different channels prior to being shown on the graphical underlay.

33. The method of claim 19 wherein at least one of the first and second underlay contents is stored in memory after being transmitted over a channel and prior to being shown on the graphical underlay.

34. The method of claim 19 wherein the first underlay content includes video.

35. The method of claim 19 wherein the first underlay content includes video advertisement.

36. The method of claim 32 wherein the video advertisement is associated with the first graphical overlay.

37. The method of claim 19 wherein the first underlay content is scaled and formatted to fit within a dimension of the associated transparent section of the first graphical overlay prior to transmission.

38. The method of claim 19 wherein the second underlay content is scaled and formatted to fit within a dimension of the associated transparent section of the second graphical overlay prior to transmission.

39. The method of claim 19 wherein the first graphical overlay further includes a second associated transparent section.

40. The method of claim 39, further comprising displaying an underlay content through the second associated transparent section of the first graphical overlay.

41. An article of manufacture, comprising:
a machine-readable medium having stored thereon instructions to:
select a first graphical overlay having an associated transparent section;
provide a graphical underlay capable to show at least one underlay content;
display a first underlay content through the associated transparent section of the selected first graphical overlay;
select a second graphical overlay having an associated transparent section; and
display a second underlay content through the associated transparent section of the selected second graphical overlay.

42. An apparatus for providing a video enhancement to an interactive television content page, the apparatus comprising:
means for selecting a first graphical overlay having an associated transparent section;
coupled to the means for selecting the first graphical overlay, means for providing a graphical underlay capable to show at least one underlay content;
coupled to the means for providing the graphical underlay, means for displaying a first underlay content through the associated transparent section of the selected first graphical overlay;
coupled to the means for selecting the first graphical overlay, means for selecting a second graphical overlay having an associated transparent section; and
coupled to the means for providing the graphical underlay, means for displaying a second underlay content through the associated transparent section of the selected second graphical overlay.

43. A method of providing a video enhancement to an interactive television content page, the method comprising:
providing at least one graphical overlay with a transparent section, the at least one graphical overlay disposed along a graphical foreplane;
providing a graphical underlay capable to show at least one underlay content, the graphical underlay disposed along a graphical backplane; and
displaying one of the underlay contents through the transparent section of one of the graphical overlays, the underlay content related to one of the graphical overlays.

44. An apparatus for providing a video enhancement to an interactive television content page, the apparatus comprising:
a display engine capable to display a graphical overlay having an associated transparent section and to display an underlay content, including video, on a graphical underlay and through the associated transparent section; and
a processor communicatively coupled to the display engine and capable to execute the display engine.

45. The apparatus of claim 44 wherein the display engine is capable to display the graphical overlay based upon an action of the user.

46. The apparatus of claim 44 wherein the display engine is capable to automatically display the graphical overlay based upon a triggering mechanism.

47. The apparatus of claim 44 wherein the graphical overlay is disposed along a graphical foreplane, and wherein the graphical underlay is disposed along a graphical backplane.

48. The apparatus of claim 44 wherein the graphical overlay includes a translucent region through which at least a portion of the underlay content can be shown.

49. The apparatus of claim 44 wherein the graphical overlay is transmitted over a first channel.

50. The apparatus of claim 44 wherein the graphical overlay includes an interactive content page.

51. The apparatus of claim 44 wherein the underlay content is transmitted over a second channel different from a first channel used to transmit the overlay content.

52. The apparatus of claim 51 wherein the underlay content is stored in memory after being transmitted over the second channel and prior to being shown on the graphical underlay.

53. The apparatus of claim 52 wherein the graphical overlay is associated with an interactive service provider and the second channel is assigned to the interactive service provider.

54. The apparatus of claim 53 wherein the interactive service provider assembles a plurality of underlay contents from at least one advertiser or at least one merchant.

55. The apparatus of claim 44 wherein the display engine is capable to format and scale the underlay content to fit within a dimension of the transparent section.
